(19) United States
(12) Patent Application Publication
(10) Pub. No.: US 2026/0148334 A1
(43) Pub. Date: May 28, 2026

(54) POINT CLOUD REGISTRATION METHOD BASED ON SEMANTIC ANNOTATION RESULTS FOR COMPLEX STRUCTURES OF SHIP HULL SEGMENTS

(71) Applicant: Dalian University of Technology, Dalian (CN)

(72) Inventors: Shilin HUO, Dalian (CN); Ji WANG, Dalian (CN); Rui LI, Dalian (CN); Fangshuai WEI, Dalian (CN); Xiao LIU, Dalian (CN); Zhenghao YIN, Dalian (CN)

(73) Assignee: Dalian University of Technology, Dalian (CN)

(21) Appl. No.: 19/432,234

(22) Filed: Dec. 24, 2025

Related U.S. Application Data
(63) Continuation of application No. PCT/CN2025/136970, filed on Nov. 24, 2025.

(30) Foreign Application Priority Data
Nov. 25, 2024 (CN) 2024116949570

(51) Int. Cl. G06T 3/14; G06F 17/11; G06T 7/35

(52) U.S. Cl. CPC G06T 3/14; G06F 17/11; G06T 7/35

(57) ABSTRACT

This disclosure discloses a coarse registration method based on an RANSAC principle and salient structures and a point cloud-model fine registration method considering multiple types of information for large-scale measured point sets generated from large components of ship hull segments. Fast and efficient coarse registration and fine registration methods are given. Point cloud registration based on deep learning methods can fully consider a wide range of information such as process constraints, inherent information of measured point clouds, and local semantic information of the point clouds, greatly improving intelligence and rationality of registration processes, at the same time, improving engineering guidance of registration results, achieving rapid error evaluation of processed components, and providing a basis for formulation of assembly parameters.

### CROSS-REFERENCE TO RELATED APPLICATIONS

The application claims priority to Chinese patent application No. 2024116949570, filed on Nov. 25, 2024, the entire contents of which are incorporated herein by reference.

### TECHNICAL FIELD

This disclosure belongs to the fields of computer graphics and three-dimensional point cloud processing, and relates to a point cloud registration method based on semantic annotation results for complex structures of ship hull segments.

### BACKGROUND

In the process of applying point cloud data to assembly and construction accuracy control, the issue of point cloud registration is particularly important. Compared with traditional point cloud registration technologies, intelligent registration can fully consider a wide range of information such as process constraints, inherent information of measured point clouds, and local semantic information of point clouds, greatly improving the intelligence and rationality of the registration process, and at the same time, improving the engineering guidance of registration results.

Point cloud identification and annotation are the core of an intelligent registration algorithm and the basic technology for realizing intelligent registration detection. In addition, traditional point cloud deep identification methods are difficult to apply to engineering measured point clouds due to various factors. Therefore, it is very important to develop efficient and feasible deep learning methods for engineering measured point clouds.

To perform complex processing of original point clouds, identification and semantic annotation must be completed in advance. Traditional manually designed description methods are difficult to meet the identification requirements of large-scale point clouds. Therefore, it is inevitable to introduce deep learning methods to achieve internal identification and annotation of point clouds based on big data samples and deep neural network structures.

Based on the identification and annotation results, preprocessing work such as noise reduction and simplification of the original point clouds can be achieved, providing an information-rich dataset for registration and error measurement. Based on the identification and annotation results, a supporting point cloud registration algorithm needs to be developed as well to achieve the goal of assisting in registration by the deep learning methods, thereby guiding the rapid and lean assembly work of large components.

For the issue of industrial precision detection, the traditional concept of registration is to place measured point clouds and a CAD design model in an appropriate pose within the same coordinate system through spatial rigid body transformation to achieve error evaluation. The most core issue at this point is the determination of transformation parameters. A point cloud registration theory is usually divided into two parts: coarse registration and fine registration. Coarse registration refers to roughly aligning the point clouds with the CAD model through certain means to provide a better initial position estimation for subsequent processing; and fine registration refers to using the initial pose obtained from coarse registration as an initial value of an algorithm to iteratively solve a local optimal solution. A two-step registration algorithm essentially corresponds to optimal solution interval search and convex optimization within the interval in the issue of non-convex function optimization. Traditional registration algorithms are limited by the high complexity of three-dimensional spatial geometric topology information, making it difficult to provide efficient and reasonable coarse registration results. For complex objects, manually-assisted matching is often used to quickly obtain good point cloud poses. At the same time, the nearest point correspondence principle is used to achieve fine registration iteration, and final results cannot truly reflect an error relationship between the point clouds and the design model. The root cause of the above problems is that traditional methods can only consider manually designed information such as curvatures, normal vectors, single-point coordinates, simple regions (planes, cylinder surfaces, etc.), and descriptor values, resulting in overly thin dimensions and levels of data processing. Expanding point cloud information and introducing efficient “identification” technologies have become efforts to improve and develop traditional registration methods.

### SUMMARY

The technical problem to be solved by this disclosure is to provide a point cloud registration method based on semantic annotation results for complex structures of ship hull segments, and to study the application of large-scale three-dimensional point clouds in rapid and lean assembly of large components in view of the above-mentioned deficiencies in the prior art. Point cloud registration based on deep learning methods can fully consider a wide range of information such as process constraints, inherent information of measured point clouds, and local semantic information of point clouds, greatly improving the intelligence and rationality of the registration process, at the same time, improving the engineering guidance of the registration results, enabling the rapid error evaluation of processed components, and providing a basis for the formulation of assembly parameters.

This disclosure discloses a coarse registration method based on an RANSAC principle and salient structures and a point cloud-model fine registration method considering multiple types of information for large-scale measured point sets generated from large components of ship hull segments. Fast and efficient coarse registration and fine registration methods, i.e., a point cloud registration method based on semantic annotation results for complex structures of ship hull segments is given. The method mainly comprises the following two steps:

### I. Coarse Registration Algorithm Based on Salient Structures:

(1) automatic coarse registration algorithm: extending a coarse registration method for constraining degrees of freedom of a spatial rigid body, and also using the salient members for constraining the degrees of freedom of the spatial rigid body; simultaneously calculating out fully constrained combinations of all identifiable members and recording them as a constraint combination table T; for a salient member group, arranging the members according to member category labels and the aforementioned constraint combination table T to form all feasible coarse registration constraint sets, and finally calculating out an optimal coarse registration result based on an RANSAC principle;
(2) manual coarse registration algorithm: for segmented and annotated original point clouds, completing manual selection of the salient members according to the constraint combination table T in the above automatic coarse registration algorithm, and thus completing coarse registration; and

### II. After Choosing Either the Automatic Coarse Registration Algorithm or the Manual Coarse Registration Algorithm, Performing a Point Cloud Fine Registration Algorithm Based on Probability Correspondence:

(1) for simplified point clouds, utilizing a point correspondence probability function fc, and giving a local correspondence probability matrix between points to be considered and their neighboring CAD points, lines, and surfaces according to a Gaussian function and spatial grid subdivision;
(2) based on the CPD probability matrix and the point cloud-CAD target optimization formula, formulating an optimization function considering the correspondence probability matrix in the form of the following formula,

$${min}_{R , t} {\sum }_{n = 1}^{N} {\sum }_{m = 1}^{M} {P}_{nm} {‖ {Rx}_{n} + t - {y}_{m} ‖}^{2} ,$$

wherein:
N: number of points in a moving point cloud;
M: number of points in a fixed point cloud;
Pₙₘ: element in the n-th row and m-th column of the correspondence probability matrix;
R: rotation matrix to be solved;
t: translation matrix to be solved;
xₙ: n-th point in the moving point cloud;
yₘ: m-th point in the fixed point cloud
based on a quaternion derivation method from Horn et al.; finally, improving an ICP algorithm with optimization equation solving results, taking the simplified point clouds and a CAD model as registration objects, making each iteration to traverse each point in the point clouds, calculating a local probability correspondence matrix, assembling a calculated local probability correspondence matrix into a global probability matrix, further solving an optimization objective function, and gradually approaching a local optimal solution.

For the technical solution described above, further, calculating out fully constrained combinations of all identifiable members is as follows: finding two structural members of the same category in the two point clouds to be registered, performing coarse registration on the two members by using a PCA method, and evaluating registration results through a coarse registration residual.

For the technical solution described above, further, a method for obtaining the salient members is as follows: formulating a saliency metric function fs that comprehensively considers surface region information, member category information, and process weight information; through calculation with the saliency metric function fs, automatically selecting top-ranked members as the salient members, and taking their set as a salient member group.

For the technical solution described above, further, the step of manual selection of the salient members comprises: selecting any group of member combinations that meet the requirements of the constraint combination table T on a point cloud display interface.

For the technical solution described above, further, the step of selecting any group of member combinations that meet the requirements of the constraint combination table T comprises: selecting any combination of three mutually non-parallel salient planes.

The coarse registration algorithm in step I mentioned above is: based on the calibrated salient structure information, candidate solutions for point cloud-model coarse registration are obtained, the spatial translation and rotation constraints corresponding to the point cloud coarse registration are considered, and a method for the fully constrained combinations of the degrees of freedom of the spatial rigid body applicable to various salient members of large ship hull components are studied, which achieves the rapid calculation of feasible solutions for coarse registration, at the same time, significantly reduces the number of corresponding relationship groups and the size of solution set for coarse registration, and reduces the time consumption of coarse registration enumeration combinations. System development of the automatic coarse registration algorithm and the manual coarse registration algorithm is carried out respectively to adapt to different engineering requirements.

For the technical solution described above, further, the point correspondence probability function fc in (1) in step II considers its 3 types of simple inherent geometric information-curvature, normal vector, and three-dimensional coordinates; considers supervoxel identification information to which points belong; considers key part information of the points and process constraint information of the neighboring CAD model; and considers surface region information to which the points belong.

For the technical solution described above, further, the point cloud simplification method in (1) in step II comprises the following steps:
\textcircled{1} based on previous point cloud identification and annotation results, calculating neighboring CAD model members of each supervoxel under a coarse registration pose, and calculating a deviation value between identification information and neighboring member information, and if there are no similar CAD model members near the supervoxel, regarding the supervoxel as a redundant structure and removing it;
\textcircled{2} for valid point clouds retained after step \textcircled{1}, taking the supervoxel as a unit, calculating a region intersection part based on a point cloud region growing algorithm as a key part, and annotating the regional intersection part as key points and key lines according to a principal member analysis method and an edge detection method, and then selecting key surfaces according to a number of points and a flatness of each region; and
\textcircled{3} finally, traversing each supervoxel for non-uniform simplification, setting a larger sampling coefficient (for example, the sampling coefficient of the key part is 0.25, and the sampling coefficient of other parts is 0.1) for the key part, and then obtaining low-throughput point clouds for subsequent fine registration.

For the technical solution described above, further, a method for calculating the neighboring CAD model members of each supervoxel under the coarse registration pose in \textcircled{1} of the point cloud simplification method uses a Hausdorff distance for calculation.

For the technical solution described above, further, the key part in \textcircled{3} of the point cloud simplification method comprises key points, key lines, and key surfaces.

The fine registration method based on the probability correspondence optimization function in step II mentioned above is: point cloud simplification and key information screening are completed through point cloud identification feature information, suitable point cloud-model local correspondence probability evaluation methods are studied, and based on the probability correspondence concept in the fine registration theory, the auxiliary role of point cloud multivariate information in the fine registration process is achieved, the point cloud-CAD model registration optimization objective function is improved, a theoretical solution of this optimization function is derived, and more reasonable and valid point cloud registration results and error evaluation information are finally obtained.

Compared with the prior art, this disclosure has the following beneficial effects:
1. The coarse registration algorithm of this disclosure is more comprehensive, and the incorporation of identified salient members for coarse registration significantly improves the efficiency of coarse registration.
2. The fine registration algorithm of this disclosure considers the information of identified members, improving the accuracy of fine registration.
3. The intelligent point cloud registration technology for large components of ship hull segments based on deep learning in this disclosure can achieve rapid error evaluation of processed components, provides a basis for formulating assembly parameters, can greatly reduce the time and labor consumption of precision measurement, and is of great significance for improving the intelligence of the shipbuilding process.

### BRIEF DESCRIPTION OF DRAWINGS

FIG. 1 is a flow diagram of a coarse registration algorithm based on salient structure extraction; and

FIG. 2 is a flow diagram of a point cloud fine registration algorithm based on probability correspondence.

### DETAILED DESCRIPTION OF THE EMBODIMENTS

This disclosure is further described in detail below with reference to the accompanying drawings and embodiments. It should be understood that the specific embodiments described herein are merely used for explaining this disclosure and are not intended to limit this disclosure. It should also be noted that, for ease of description, only the parts related to this disclosure are shown in the accompanying drawings instead of all structures.

According to a point cloud registration method based on semantic annotation results for complex structures of ship hull segments of this disclosure, its key technologies lie in the coarse registration method based on the RANSAC principle and the salient structures, and the point cloud-model fine registration method of multiple types of information is considered.

### I. Coarse Registration Algorithm Based on Salient Structures:

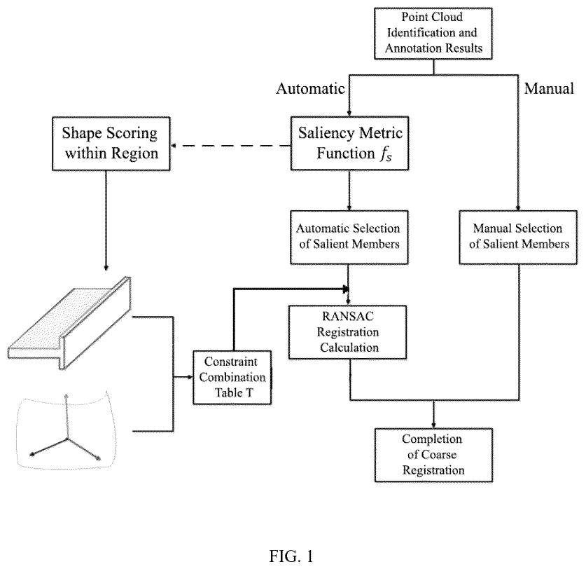

As shown in FIG. 1, based on the supervoxel identification and annotation results, system development of the automatic coarse registration algorithm and the manual coarse registration algorithm is carried out respectively:

### 1. For the Automatic Coarse Registration Algorithm:

A saliency metric function fs that comprehensively considers surface region information, member category information, and process weight information is formulated. Through calculation with the saliency metric function fs, the top-ranked members are automatically selected as a salient member group; the popular coarse registration methods for constraining the degrees of freedom of the spatial rigid body by virtue of three-point, three-plane, three-sphere, cylindrical surface and conical surface constraints are expanded—the salient members are used for constraining the degrees of freedom of the spatial rigid body, and effective constraints on spatial translations are achieved by identifiable members. Simultaneously, fully constrained combinations for all identifiable members are calculated out (by finding two structural members of the same category in the two point clouds to be registered, performing coarse registration on the two members using the PCA method, and evaluating the registration results through the coarse registration residual), and recorded as a constraint combination table T (containing constraint combinations capable of constraining the degrees of freedom of the spatial rigid body, for example, a certain salient member forms a constraint combination with points, surfaces, and spheres). For the salient member group, the members are arranged according to member category labels and the aforementioned constraint combination table T to form all feasible coarse registration constraint sets, and finally the optimal coarse registration result is calculated based on the RANSAC principle.

### 2. For the Manual Coarse Registration Algorithm:

A simple and direct human-computer interaction interface is developed to display the segmented and annotated original point clouds with different color levels. The operator only needs to complete manual selection of salient members according to the constraint combination table T in the above automatic coarse registration algorithm and select any group of member combinations that meet the requirements of the constraint combination table T on the point cloud display interface (e.g., any combination of three mutually non-parallel salient planes) to complete the coarse registration.

### II. Point Cloud Fine Registration Algorithm Based on Probability Correspondence:

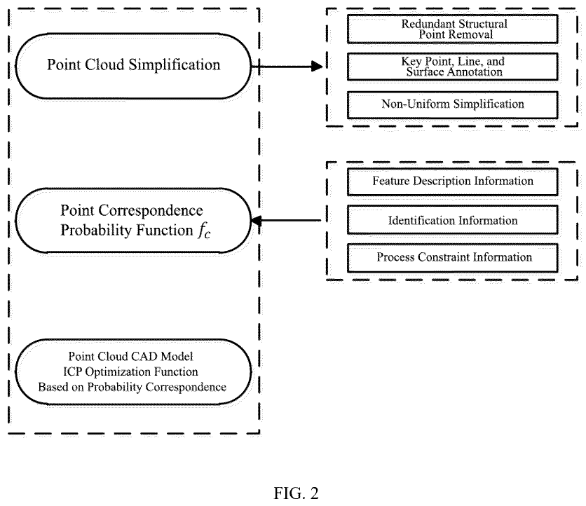

As shown in FIG. 2, the flow diagram of the point cloud fine registration algorithm based on probability correspondence is provided.

### 1. Point Cloud Simplification:

(1) Based on the previous point cloud identification and annotation results, neighboring CAD model members of each supervoxel is calculated (using the Hausdorff distance) under a coarse registration pose, and a deviation value (category deviation, e.g., the deviation value of the same category is 0, and the deviation value of different categories is) between identification information and neighboring member information is calculated, and if there are no similar CAD model members near the supervoxel, the supervoxel is regarded as a redundant structure and removed;
(2) for valid point clouds retained after step (1), the supervoxel is taken as a unit, a region intersection part is calculated based on a point cloud region growing algorithm as a key part, and the regional intersection part is annotated as key points and key lines according to a principal member analysis method and an edge detection method, and then key surfaces are selected according to a number of points and a flatness of each region; and
(3) finally, each supervoxel is traversed for non-uniform simplification, a larger sampling coefficient (for example, the sampling coefficient of the key part is 0.25, and the sampling coefficient of other parts is 0.1) is set for the key part (key points, key lines, and key surfaces), and then low-throughput point clouds are obtained for subsequent fine registration.

### 2. Point Correspondence Probability Function Fc:

For the simplified point clouds, by considering its 3 types of inherent simple geometric information-curvatures, normal vectors, and three-dimensional coordinates, the point correspondence probability function fc considers the supervoxel identification information to which the points belong; considers the key part information of the points and the process constraint information of the neighboring CAD model, and considers the surface region information to which the points belong, and gives the local correspondence probability matrix between the points to be considered and their neighboring CAD points, lines, and surfaces according to the Gaussian function and spatial grid subdivision (calculated from the point correspondence probability function).

### 3. Point Cloud-CAD Model ICP Optimization Function Based on Probability Correspondence:

Based on the CPD probability matrix and the point cloud-CAD target optimization formula, an optimization function considering the correspondence probability matrix in the form of the following formula, min_{R,t}Σₙ₌₁^{M}Σₘ₌₁^{M}Pₙₘ∥Rxₙ+t−yₘ∥², is formulated (the specific meanings of the variables involved in the function are as follows). Based on the quaternion derivation method from Horn et al., the solution of the optimization equation is completed. Finally, an ICP algorithm is improved with optimization equation solving results, the simplified point clouds and a CAD model (STL triangular facet set) are used as registration objects, each iteration traverses each point in the point clouds, a local probability correspondence matrix is calculated, a calculated local probability correspondence matrix is assembled into a global probability matrix, an optimization objective function is further solved, and a local optimal solution is gradually approached.
N: Number of points in the moving point cloud
M: Number of points in the fixed point cloud
Pnm: Element in the n-th row and m-th column of the correspondence probability matrix
R: Rotation matrix to be solved t: Translation matrix to be solved
xn: n-th point in the moving point cloud
ym: m-th point in the fixed point cloud

The above descriptions are merely preferred specific embodiments of this disclosure, but the protection scope of this disclosure is not limited thereto. Variations or substitutions that can be easily conceived by those skilled in the art within the technical scope disclosed by this disclosure should be included within the protection scope of this disclosure. Therefore, the protection scope of this disclosure should be determined by the protection scope of the claims.

What is claimed is:

1. A point cloud registration method based on semantic annotation results for complex structures of ship hull segments, comprising the following steps:
I. coarse registration algorithm based on salient structures:
(1) automatic coarse registration algorithm: extending a coarse registration method for constraining degrees of freedom of a spatial rigid body, and also using the salient members for constraining the degrees of freedom of the spatial rigid body; simultaneously calculating out fully constrained combinations of all identifiable members and recording them as a constraint combination table T; for a salient member group, arranging the members according to member category labels and the aforementioned constraint combination table T to form all feasible coarse registration constraint sets, and finally calculating out an optimal coarse registration result based on an RANSAC principle;
(2) manual coarse registration algorithm: for segmented and annotated original point clouds, completing manual selection of the salient members according to the constraint combination table T in the above automatic coarse registration algorithm, and thus completing coarse registration; and
II. after choosing either the automatic coarse registration algorithm or the manual coarse registration algorithm, performing a point cloud fine registration algorithm based on probability correspondence:
(1) for simplified point clouds, utilizing a point correspondence probability function fc, and giving a local correspondence probability matrix between points to be considered and their neighboring CAD points, lines, and surfaces according to a Gaussian function and spatial grid subdivision;
(2) based on a CPD probability matrix and a point cloud-CAD target optimization formula, formulating an optimization function considering the correspondence probability matrix in the form of formula I, and completing optimization equation solving based on a quaternion derivation method from Horn et al.; finally, improving an ICP algorithm with optimization equation solving results, taking the simplified point clouds and a CAD model as registration objects, making each iteration to traverse each point in the point clouds, calculating a local probability correspondence matrix, assembling a calculated local probability correspondence matrix into a global probability matrix, further solving an optimization objective function, and gradually approaching a local optimal solution, wherein:
the formula I is as follows:
$${min}_{R , t} {\sum }_{n = 1}^{N} {\sum }_{m = 1}^{M} {P}_{nm} {‖ {Rx}_{n} + t - {y}_{m} ‖}^{2}$$
N: number of points in a moving point cloud; M: number of points in a fixed point cloud; Pnm: element in the n-th row and m-th column of the correspondence probability matrix; R: rotation matrix to be solved; t: translation matrix to be solved; xn: n-th point in the moving point cloud; and ym: m-th point in the fixed point cloud.

2. The method according to claim 1, wherein calculating out fully constrained combinations of all identifiable members is as follows: finding two structural members of the same category in the two point clouds to be registered, performing coarse registration on the two members by using a PCA method, and evaluating registration results through a coarse registration residual.

3. The method according to claim 1, wherein a method for obtaining the salient members is as follows: formulating a saliency metric function fs that comprehensively considers surface region information, member category information, and process weight information; and through calculation with the saliency metric function fs, automatically selecting top-ranked members as the salient members, and taking their set as the salient member group.

4. The method according to claim 1, wherein the step of manual selection of the salient members comprises: selecting any group of member combinations that meet the requirements of the constraint combination table T on a point cloud display interface.

5. The method according to claim 1, wherein the step of selecting any group of member combinations that meet the requirements of the constraint combination table T comprises: selecting any combination of three mutually non-parallel salient planes.

6. The method according to claim 1, wherein the point correspondence probability function fc in (1) in step II considers its 3 types of simple inherent geometric information-curvatures, normal vectors, and three-dimensional coordinates; considers supervoxel identification information to which points belong; considers key part information of the points and process constraint information of the neighboring CAD model; and considers surface region information to which the points belong.

7. The method according to claim 1, wherein the point cloud simplification method in (1) in step II comprises the following steps:
\textcircled{1} based on previous point cloud identification and annotation results, calculating neighboring CAD model members of each supervoxel under a coarse registration pose, and calculating a deviation value between identification information and neighboring member information, and if there are no similar CAD model members near the supervoxel, regarding the supervoxel as a redundant structure and removing it;
\textcircled{2} for valid point clouds retained after step \textcircled{1}, taking the supervoxel as a unit, calculating a region intersection part based on a point cloud region growing algorithm as a key part, and annotating the regional intersection part as key points and key lines according to a principal member analysis method and an edge detection method, and then selecting key surfaces according to a number of points and a flatness of each region; and
\textcircled{3} finally, traversing each supervoxel for non-uniform simplification, setting a larger sampling coefficient for the key part, and then obtaining low-throughput point clouds for subsequent fine registration.

8. The method according to claim 1, wherein a method for calculating the neighboring CAD model members of each supervoxel under the coarse registration pose in \textcircled{1} of the point cloud simplification method uses a Hausdorff distance for calculation.

9. The method according to claim 1, wherein the key part in \textcircled{3} of the point cloud simplification method comprises key points, key lines, and key surfaces.
